(19) United States
(12) Patent Application Publication
(10) Pub. No.: US 2009/0077884 A1
(43) Pub. Date: Mar. 26, 2009

(54) METHOD FOR PLANTING DESIGN

(76) Inventors: Roy E. Diblik, Burlington, WI (US); Christa L. Orum-Keller, Maple Park, IL (US)

Correspondence Address: Mathew R. P. Perrone, Jr.;Brie A. Crawford, 210 South Main Street, Algonquin, IL, 60102, US

(21) Appl. No.: 11/858,235

(22) Filed: Sep. 20, 2007

(51) Int. Cl. A01C 1/00; A01C 14/00

(52) U.S. Cl. 47/1.1 R; 111/100

(57) ABSTRACT

A method for placing a set of plants according to a calculated pattern factors in plant durability, appearance and cooperation. Multiple species or cultivars, that is plants are combined in a planting technique taking into account cultural considerations, sun, color, soil moisture and drainage, soil type or composition, longevity of the various plant species, wind conditions, weather or winter conditions, manmade influences on plant culture or any combination thereof.

This invention relates to a method for a planting design and more particularly to a method for a planting design capable of producing a more appealing appearance, with a synergistic combination of plants.

### BACKGROUND OF THE INVENTION

In the planting of a garden, careful selection of plants is required. Even so, the standard system of planting usually includes setting monocultures grouped side by side. Other techniques or cultural considerations relate to the effect of sun on a plant or the color of the plant. For example, some plants do well with heavy exposure to the sun, while some plants do well with medium exposure to the sun, and, some plants do well with light exposure to the sun.

Color is also a major factor in choosing plants. A plant choice considering color affects the appearance and the arrangement of the plants. In many cases, such selection is artistic, rather than a scientific or another capable means of being set to a specific plan. To provide a more efficient planting with a desired appearance, a predictable method of planting a garden and setting out the plants is clearly desirable. Not only can the consumer benefit therefrom, the plant supplier and the landscaper can perform their work more efficiently at more reasonable cost.

Because of the problems of making an appropriate plant selection and achieving cooperation between plants, the default position of all concerned is to usually use the same plants over and over. Often the plant palette for a designer or a landscape architect includes only about five to ten plants. Most likely, the number of plants cannot exceed fifteen.

Even so, much guesswork is involved in determining what the general spacing between plants should be. Furthermore, indicated area of monoculture in a designed plan still complicates the system. The factors combine to produce a less appealing appearance with a less interesting looking group of plant arrangements. This is caused by the planting arrangement having either fewer colors, clashing colors, a too simple appearance, a lack of elegance or any combination thereof.

Furthermore, there are higher, unknown, or unpredictable maintenance activities and costs, Each monoculture requires different maintenance care. If some plants do not survive in a monoculture, they must be replaced and often the replacements die due to cultural factors. A monoculture is a self-destructive system. Since the monoculture is not system based (as in a natural occurring ecological system) maintenance costs for each group of plants are distinctly different, hard to plan for, or hard to predict. Therefore, a budget for maintenance is extremely difficult or even impossible.

The monoculture usually has a short term impact, but also a shorter “shelf life”. The usual lifetime for a monoculture planting as a whole is five years or less. Even if the planting is sustained, it is done so only by replacing plants and over time, the majority of the planting is actually replanted or replaced.

There are also many maintenance challenges of monocultures. Such a planting is very difficult to maintain. The plants in the monoculture system tend to have higher disease rates. That disease rate leads to a rapid spread of disease. A higher percentage of plant losses then results. Losses mean more replacements along with additional work and expense.

Such plant arrangements also use a substantial amount of water. With such water usage, the desired appearance can be obtained. With water being a critical shortage sometimes, it is very desirable to achieve this appearance or crop success, with reduced water usage. Yet no such system exists.

Various plants have different water requirements. Without a proper plan for planting, proper watering of plants can be a problem. Thus, it is very desirable to simplify the watering process.

Thus it may be seen that being able to select a wider range of plants and place in an efficient fashion results in better appearing set of plants. If the better appearing set is also more durable or has greater sustainability, even greater advantages are obtained. Thus, a simplified method of setting and using a wider, more durable range of plants can be extremely useful.

### SUMMARY OF THE INVENTION

Among the many objectives of the present invention is the provision of a method for placing a set of plants in a desired position quickly and efficiently.

Another objective of the present invention is the provision of a method for placing a set of plants, which provides a durable set of plants.

Yet another objective of the present invention is the provision of a method for placing a set of plants, which maximizes appearance.

Still another objective of the present invention is the provision of a method for placing a set of plants, which maximizes cooperation between plants.

Also, an objective of the present invention is the provision of a method for placing a set of plants, which minimizes plant disease problems.

Moreover, an objective of the present invention is the provision of a method for placing a set of plants, which minimizes cost.

A further objective of the present invention is the provision of a method for placing a set of plants, which minimizes water usage.

These and other objectives of the invention (which other objectives become clear by consideration of the specification, claims and drawings as a whole) are met by providing a method for placing a set of plants according to a calculated pattern factoring plant durability, appearance and cooperation.

### BRIEF DESCRIPTION OF DRAWINGS

FIG. 1 depicts a calculation chart 100 to determine the number of plants suitable for use in a method of placing a set of plants in accordance with this invention.

FIG. 2 depicts an application of FIG. 1 to pattern of squares 12 inches on a side.

FIG. 3 depicts an application of FIG. 1 to pattern of squares 15 inches on a side.

FIG. 4 depicts an application of FIG. 1 to pattern of squares 15 inches on a side.

Throughout the figures of the drawings, where the same part appears in more than one figure of the drawings, the same number is applied thereto.

### DESCRIPTION OF THE PREFERRED EMBODIMENTS

Multiple species or cultivars, that is plants, are combined in a planting technique taking into account cultural considerations, sun, color, soil moisture and drainage, soil type or composition, longevity of the various plant species, wind conditions, weather or winter conditions, manmade influences on plant culture or any combination thereof. Manmade influences include, but are not limited to, irrigation systems, structures, lighting systems, fertilizing systems and the like. Using this method, the aesthetic appearance has a highly desirable appearance, in more reliably predictable fashion.

To determine the best combinations of plants, one looks for plants, which thrive in a specific combination of cultural conditions or physical conditions. Plants may be placed together in relation to communities of plants based on time required to maintain each member of the community. Using the method of this invention, an experienced horticulturist can design and carry out a proper set of plants.

By using the method of this invention, an experienced horticulturist can choose from hundreds of plant species and cultivars based on these three areas of consideration. The first basis for selecting a plant or group of plants is cultural requirements including, but not limited to, optimized growing conditions. The second area is appearance, based on elements such as individual flowering time, growth rate, structure, and growth plant. The third area is the value and effect or aesthetic impact of the planting.

By considering these factors, the horticulturist can recommend specific spacing based on horticulture experience and plant relationships; indicate a minimum square meter area for which the plant combination will be effective; and determine an appropriate ratio of plants. The horticulturist may even provide a mathematical equation for this purpose, which is adaptable to various situations.

Then eventually placement recommendations for users of the system can determine the appropriate number of species to create the combination planting with their input only being the area (in square feet or square meters) and the conditions of the site.

With these procedures, the results of the planted area can be efficient and aesthetically pleasing. Installation cost per square meter is the same for the system of this invention as it is for those of prior art systems. Even so, a more appealing appearance and a more sophisticated look result. These features, in turn, provide greater interest and attractiveness to the person experiencing the garden or planting.

These advantages occur because of greater color variety, greater interest, greater intention or interaction of color, and improved texture and effect. Then there comes a possibility for varied, but ordered combinations, with a harmonious appearance. Additionally, because these features of all plants are factored in, there is a known or predictable relationship to maintenance or activities costs.

Also, with these plant collections, there is a variety of blooming times. As a result, color and appearance will extend over a longer period of time in the garden area. The even water requirements of the plants also contribute to the efficiency of the planted area.

The plant combination is more healthy. The plant combinations mimic natural occurring ecological systems which promote the health of the community. Each plant combination system requires the same maintenance care. Because of the diversity of the community (plant combination), it is less vulnerable to disease. If a disease strikes, it will only impact a small portion of the plant community which can be modified with a new or more resilient selection without having to replace a vast area. Fewer plants need to be replaced because they are well suited to the cultural environment.

The plant combination is compiled or designed to thrive based on the specific cultural characteristics of the site. Therefore, the maintenance costs can be predicted. The system can be used for budgeting purposes and a designer or planner can change plant combinations to fit the cost to maintain an area. No “shelf life” exists for a plant community. The nature of a community is ongoing with subtle adjustments for continual sustained existence. The result is a lower annual cost and lower lifetime sustaining cost.

Included in the maintenance benefits of this invention are many desirable features. There are reduced disease rates, controlled spread of disease, reduced percentage of replacement planting, predictable maintenance costs prior to planting, and longevity of planting. There are also reduced maintenance costs as less pesticides, fertilizer, deadheading, pruning, and weeding are necessary.

Such a planting system can also reduce the amount of water used to maintain the desired appearance and function of the plants. The combination of the plants factors the water requirements for each plant and permits a desired appearance, using less water.

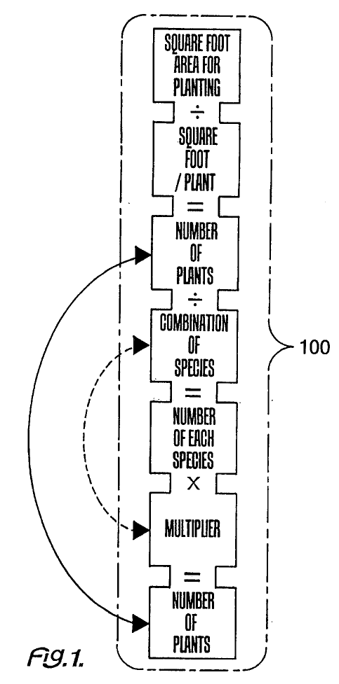

Turn now to FIG. 1, the solution 100 is set by determining the area for planting 120 and dividing by the area required for each plant 122. Then the number of plants 124 is divided by combination of species 126 to get the number of each species 128. Then the number of each species 128 has the multiplier 130 applied by division to obtain the number plants 132.

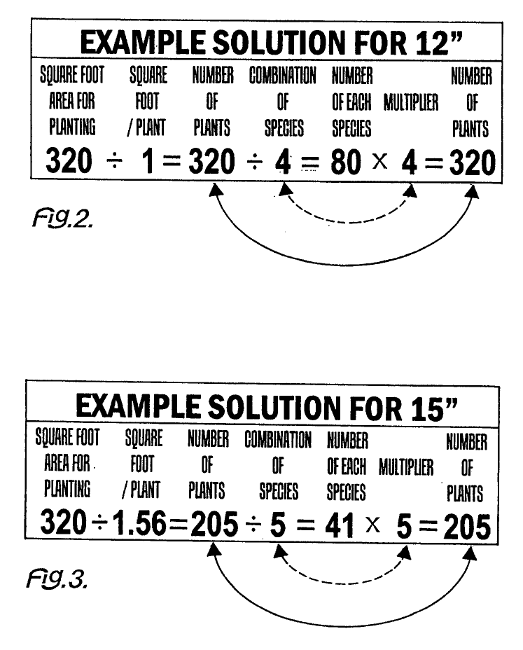

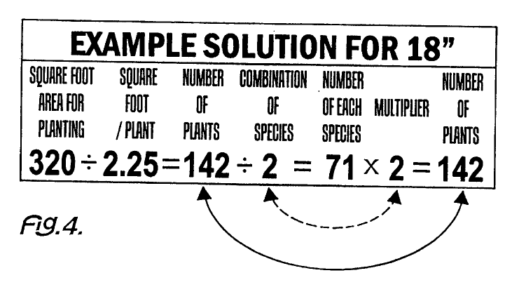

FIG. 2 depicts FIG. 1 assuming 30 square centimeters or one square foot for the area required for each plant 122. FIG. 3 depicts FIG. 1 assuming 50 square centimeters or 1.56 square feet for the area required for each plant 122. FIG. 4 depicts FIG. 1 assuming 70 square centimeters or 2.25 square feet for the area required for each plant 122.

The following examples illustrate without unduly limiting the invention.

### Example One

According to the prior art, an area of about 2.5 meters by about 3.5 meters (about eight feet by about 12 feet) area is planted, using the technique of the prior art. Two different types of plants are used including clover and gladiola. Up to about eleven percent of each type is diseased, defective or subject to some other malady. The water requirements required and area covering sprinkler, for two hours a day, one hour at time at least eight hours apart. The maintenance requires 9.75 hours a growing season in addition to mulching every two years. The maintenance includes weeding, occasional pruning of broken stems, and possibly cutting back the entire area in early to mid-March.

### Example Two

According to the prior art, an area of about 4.5 meters by about 5.7 meters (about 15 feet by about 20 feet) area is planted, using the technique of the prior art. Seven different types of plants are used including clover, gladiola, violets, and four types of roses. Example 2 is a largely purple and blue palette and uses 13 rose-colored Stachys officinalis “Pummelo”, 10 Amsonia orientalis ‘Blue Ice’ and three Baptisia×hybrid ‘Purple Smoke’. Up to about eleven percent of each type is diseased, defective or subject to some other malady. The water requirements required and area covering sprinkler, for two hours a day, one hour at time at least eight hours apart. The maintenance requires 9.75 hours a growing season in addition to mulching every two years. The maintenance includes weeding, occasional pruning of broken stems, and possibly cutting back the entire area in early to mid-March.

### Example Three

When considered with FIG. 1 and planted according to this invention, Example 3 is selected for an area with average, clay-loam soil. The plants that are selected require regular watering during the establishment phase and only during periods of drought thereafter. If Example two is planted in about 2.5 meters by 3.5 about meters (about eight feet by about 12 feet) area, the maintenance requires 4.75 hours a growing season in addition to mulching every three to four years. The maintenance includes weeding, occasional pruning of broken stems, and possibly cutting back the entire area in early to mid-March before the crocus bulbs come up.

Example 3, in an about 2.5 meters by 3.5 about meters (about eight feet by about 12 feet) area, includes 47 plants. This combination includes two species of grasses: Sesleria autumnalis (10 plants) and Molinia caerulea, ‘Moorflamme’ (11 plants).

Scattered through the Sesleria autumnalis are yellow-flowering Allium moly and mixed Crocus chrysanthus. Groups of five to seven pink-flowering Tulip Greigii ‘Toronto’ are scattered through the Molinia caerulea and Stachys officinalis. Groups of five to seven yellow-flowering Tulip Tarda are mixed among the Sesleria autumnalis and Amsonia orientalis. Finally, single Allium christophii bulbs are planted three to four feet apart in a drift through the Molinia caerulea and Stachys officinalis.

### Example 4

When considered with FIG. 1 and planted according to this invention, Example 4 has 51 plants in an about 2.5 meters by 3.5 about meters (about eight feet by about 12 feet) area. Example 3 requires weeding and deadheading to keep the ‘Happy Returns’ daylilies reblooming. It also requires cutting back the entire area in early spring.

Example 4 uses 14 Sesleria autumnalis and nine Molinia caerulea ‘Moorflamme’. There are eleven ‘Happy Returns’ daylilies to add color with their sunny yellow blooms. In contrast, six Salvia×sylvestris ‘Wesuwe’ and three Baptisia×hybrid “Purple Smoke” add a deep purple aspect. While eight Geranium×hybrid “Tiny Monster”, provide a ground-covering layer of pink flowers lined with burgundy veins.

Allium moly and Crocus chrysanthus are scattered through the Sesleria autumnalis. Tulip Greigii and Tulip Tarda bulbs are planted in groups of five to seven each among the Sesleria autumnalis and Geranium×hybrid ‘Tiny Monster’. Alium christophii bulbs are planted about 0.9 meter to about 1.4 meters (1 to 4 feet apart in drifts amount the Salvia×sylvestris ‘Wesuwe’ and ‘Happy Returns’.

### Mathematical Formulas

When considered with the above examples, and FIG. 1, FIG. 2, FIG. 3, and FIG. 4; techniques of this invention can be used to determine what types and how many of a series of plants are to be planted. A series of steps and mathematical calculations determine the number and types of plants which should be planted. First, a landscape professional determines the site conditions, soil characteristics, drainage, exposure, amount of sun, and any other factor relating to the growing conditions of the area. Then, the user must decide which series of partner combinations will be planted in the area. This series of partner combinations is derived from a list which is to be used with this invention. The area to be landscaped must be measured. For the following illustration, an about 2.5 meters by 3.5 about meters (about eight feet by about 12 feet) area is planted using the technique of this invention.

Once a desired grouping of plants is selected, based on environmental conditions and user preference, a series of calculations can be used. There are terms used in the series of calculations which must be understood. For example, the base multiplier is the number of plants in each combination of plants to used in the area, and is derived from the list which is to be used with this invention. The base multiplier is not to be confused with the number of varieties or plant species in each partner combination. The plant multiplier is the number after figuring the total number of plants divided by the base multiplier. The plant partner ratio is the number of plants per variety per combination.

Clearly, each plant partner combination has at least two varieties or plant species therein. Any number of species or plant varieties can be in the plant partnership. That number is easily determined by the area to be planted and consideration of the factors set forth herein.

To begin calculations for an area which is to be planted, first the area is measured. Secondly, one divides the planting area by the area required for a plant to have viability. Third, one divides the total number of plants by the base multiplier which results in the plant multiplier. Fourth, one multiplies the plant multiplier by the plant partner ratio for each species which results in the number of each plant. The plant partner ratio is derived from the list that is used with this invention and set forth in FIG. 1. These figures are interrelated to determine the plants fitting into the desired area. Then, the planting is carried out within the above parameters.

For example, it is assumed that the area is about 2.5 meters by 3.5 about meters (about eight feet by about 12 feet) area. The square meter per plant requirement can be determined from FIG. 1 and depicts the area of ground or soil required for the plant to have viability. The square meters of planting area are divided by the square meter requirement for each plant. This result is the total number of plants required to plant the area, when those requirements are considered. The square meter per plant is derived from the list of FIG. 1, or other horticultural sources, which may be used with this invention.

This application—taken as a whole with the abstract, specification, claims, and drawings—provides sufficient information for a person having ordinary skill in the art to practice the invention disclosed and claimed herein. Any measures necessary to practice this invention are well within the skill of a person having ordinary skill in this art after that person has made a careful study of this disclosure.

Because of this disclosure and solely because of this disclosure, modification of this tool can become clear to a person having ordinary skill in this particular art. Such modifications are clearly covered by this disclosure.

What is claimed and sought to be protected by Letters Patent is:

1. A method for a planting design comprising:
a) selecting a set of plants based on the cultural requirements thereof;
b) refining the set of plants based on the appearance thereof;
c) setting a pattern for positioning the set of plants in a desired area;
d) assessing an aesthetic impact for the pattern; and
e) positioning the set of plants in the desired area.

2. The method for a planting design of claim 1 further comprising:
a) the cultural requirements being at least one consideration selected from the group consisting of sun, color, soil moisture and drainage, soil type or composition, longevity of each member of the set of plant, wind conditions, weather, and at least one manmade influence on plant culture; and
b) the set of plants providing a calculated, predictable appearance.

3. The method for a planting design of claim 2 further comprising:
a) the at least one manmade influences including an irrigation system, a support structure, a lighting system, and a fertilizing system; and
b) the pattern for the plants being a calculated pattern.

4. The method for a planting design of claim 3 further comprising:
a) the appearance being based on individual flowering time, growth rate, and structure; and
b) the combination of plants being based on time required to maintain each member of the combination.

5. The method for a planting design of claim 4 further comprising:
a) the combination of plants being based on an appropriate space;
b) the combination of plants having an appropriate ratio;
c) the combination of plants mimicking a natural ecological systems;
d) the combination of plants requiring the same maintenance care; and
e) the combination of plants being resilient.

6. A method for a planting an area of land comprising:
a) determining related factors for growing conditions in a desired area;
b) determining a set of plant partner combinations to be planted in the desired area;
c) determining a size of the desired area;
d) determining a base multiplier for a number of a plant variety to be used; and
e) arranging the plant partner combination.

7. The method of claim 6 further comprising:
a) measuring the area to planted for a planting area;
b) dividing the planting area by an area required for a plant to have viability;
c) dividing a total number of plants for the planting area by the base multiplier to obtain a plant multiplier; and
d) multiplying the plant multiplier by the plant partner ratio for each species which results in the number of each plant.

8. The method of claim 7 further comprising:
a) the related factors are at least one factor selected from the group consisting of site conditions, soil characteristics, drainage, exposure, and amount of sun; and
b) a list of plant characteristics is used to determine the plant partners.

9. The method of claim 8 further comprising:
a) the area being about 2.5 meters by about 3.5 meters; and
b) the plants being 10 Sesleria autumnalis and 11 Molinia caerulea, 11 Moorflamme, 5 to 7 pink-flowering Tulip Greigii, 5 to 7 Molinia caerulea and Stachys officinalis, 5 to 7 yellow-flowering Tulip Tarda being mixed among the 10 to 20 Sesleria autumnalis and 10 to 20 Amsonia orientalis and 4 single Allium christophii bulbs being planted three to four fee apart the Molinia caerulea and Stachys officinalis.

10. The method of claim 8 further comprising:
a) the area being about 2.5 meters by about 3.5 meters; and
b) the plants being 4 uses 14 Sesleria autumnalis and nine Molinia caerulea Moorflamme, Happy Returns daylilies, 6 Salvia×sylvestris Wesuwe, 3 Baptisia×hybrid Purple Smoke, 8 Geranium×hybrid Tiny Monster, 5 to 7 Allium moly and Crocus chrysanthus, 5 to 7 Tulip Greigii, 5 to 7 Tulip Tarda bulbs, and 5 to 7 Alium christophii bulbs are planted three to four feet apart in drifts amount the Salvia×sylvestris of the type Wesuwe and Happy Returns.
